(19) United States
(12) Patent Application Publication
(10) Pub. No.: US 2013/0231956 A1
(43) Pub. Date: Sep. 5, 2013

(54) KNOWLEDGE EXTRACTION AND EXCHANGE METHOD AND APPARATUS

(71) Applicants: Imran N. Chaudhri, Potomac, MD (US); Shahram Shawn Dastmalchi, San Ramon, CA (US); Robert Derward Rogers, Pleasanton, CA (US); Vishnuvyas Sethumadhavan, Mountain View, CA (US)

(72) Inventors: Imran N. Chaudhri, Potomac, MD (US); Shahram Shawn Dastmalchi, San Ramon, CA (US); Robert Derward Rogers, Pleasanton, CA (US); Vishnuvyas Sethumadhavan, Mountain View, CA (US)

(21) Appl. No.: 13/747,336

(22) Filed: Jan. 22, 2013

Related U.S. Application Data
(60) Provisional application No. 61/590,330, filed on Jan. 24, 2012.

(51) Int. Cl. G06F 19/00; G06Q 50/24

(52) U.S. Cl. CPC G06F 19/3443; G06Q 50/24
USPC 705/3

(57) ABSTRACT

A medical information navigation engine (“MINE”) is provided. In some embodiments, the system computes a current patient encounter vector for a current patient encounter, and then an optimal patient encounter vector is computed by assuming a best case patient encounter in accordance with the organizational objectives. The system is then able to compute the difference between the best case encounter and the current patient encounter. This difference is used to compute a corresponding payoff using an intelligent matrix.

### CROSS REFERENCE TO RELATED APPLICATION

This non-provisional application claims the benefit of provisional application No. 61/590,330 filed on Jan. 24, 2012, entitled “Knowledge Extraction and Exchange Method and Apparatus”, which application is incorporated herein in its entirety by this reference.

### BACKGROUND

The present invention relates generally to a medical information engine, and particularly to management and consolidation of medical information which enables computation of payoffs that track encounters.

Despite rapid growth of innovation in other fields in recent decades, the world of medical information, including patient medical records, billing, referrals, and a host of other information, has enjoyed little to no useful consolidation, reliability, or ease-of-access, leaving medical professionals, hospitals, clinics, and even insurance companies with many issues, such as unreliability of medical information, uncertainty of diagnosis, lack of standard, and a slew of other related problems.

One of the challenges facing those in the medical or related areas is the number of sources of information, the great amount of information from each source, and consolidation of such information in a manner that renders it meaningful and useful to those in the field in addition to patients. Obviously, this has contributed to increased medical costs and is perhaps largely attributed to the field suffering from an organized solution to better aid the medical professionals, to better aid those requiring more reliable patient history and those requiring more control and access over such information.

Currently, payoffs for medical encounters are not tied to the outcome. A physical therapy session is paid the same regardless of if the patient gains added function or not. This incentivizes providers to be inefficient, and prioritize quantity of care over the quality of care.

It is therefore apparent that an urgent need exists for a medical information navigation engine (“MINE”) capable of managing medical information in a manner that is enables the calculation of payoffs in response to the outcome of an encounter. Such a system will increase care efficiency and increase care quality.

### SUMMARY

To achieve the foregoing and in accordance with the present invention, systems and methods for managing medical information are provided. In particular, systems and methods for a Medical Information Navigation Engine (“MINE”) is provided which can compare actual patient encounters with optimal encounters to generate a payoff.

In some embodiments, the system computes a current patient encounter vector for a current patient encounter, and then an optimal patient encounter vector is computed by assuming a best case patient encounter in accordance with the organizational objectives. The system is then able to compute the difference between the best case encounter and the current patient encounter. This difference is used to compute a corresponding payoff using an intelligent matrix.

In some embodiments, the patient encounter vectors and corresponding payoffs are collected to create a linear system. The linear system is optimized to obtain intelligence for the MINE. In some cases the difference between the optimal patient encounter vector and the current patient encounter vector is provided to a querying user and a querying electronic health record (EHR) system.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 shows a medical system 100, in accordance with an embodiment of the invention;

FIG. 2 shows further details of the system 100, particularly the MINE 112 thereof;

FIG. 3 shows an exemplary embodiment implementing the system 100 using various devices;

FIG. 4 shows a block diagram of a knowledge extraction system 450, in accordance with an embodiment of the invention;

FIG. 5 shows a flow chart of some of the steps performed by the unit 454 of FIG. 4, in conjunction with some of the blocks of FIG. 4 and in accordance with a method of the invention;

FIG. 6 shows an example of the knowledge extraction and exchange unit 454 and the client application 474 and examples of knowledge providers 482;

FIGS. 7 and 8 show a model of a healthcare reimbursement system, in accordance with a method and embodiment of the invention;

FIGS. 9-11 each show a graph of the intelligence, shown in the x-direction, versus value, shown in the y-direction, of various performance improvements realized using the various methods and embodiments of the invention;

FIGS. 12-18 show an example of a patient/user, Joan Sample, benefiting from the process of extracted information used to determine potential conditions, in accordance with a method of the invention;

FIG. 19 shows MI and DVT extracted from otherwise hidden information, other provider EHRs and scanned documents, by using the knowledge-based extraction methods and embodiments of the invention;

FIG. 20 shows a flow chart of the steps for determining the intelligence (I) of a healthcare system, in accordance with a method of the invention; and

FIG. 21 shows a flow chart of the steps for application of hierarchal condition categories (HCC), in accordance with a method of the invention.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

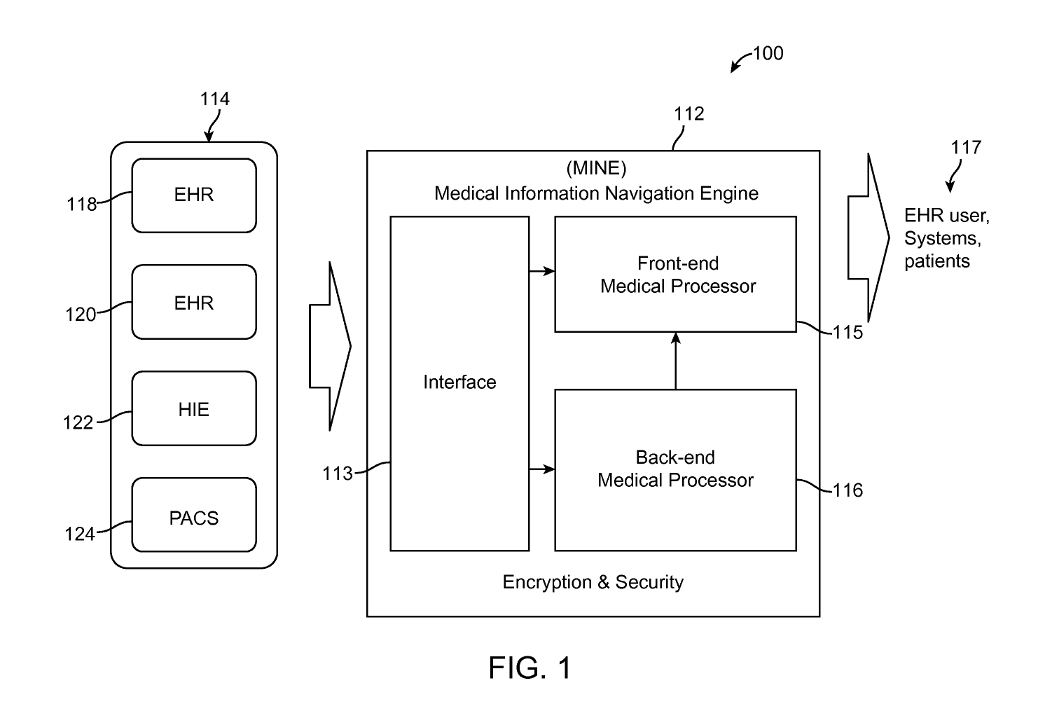

Referring now to FIG. 1, medical system 100, in accordance with an embodiment of the invention. The system 100 is shown to include medical source 114, a medical information navigation engine (MINE) 112, and medical information consumers (also referred to herein as “output” or “medical output”) 117. The medical source 114 are shown to include an electronic health record (EHR) 118, EHR 120, health information exchange (HIE) 122, and a picture archiving and communication system (PACS) 124. The MINE 112 is shown to include interface 113, a back-end medical processor 116, and a front-end medical processor 115.

“Medical information”, as used herein, refers to any health-related information, including but not limited to patient medical records, patient entered information, care team entered information, healthcare device generated information, and billing information.

The source 114 generally provides various medical information to the MINE 112. For example, the EHRs 118 and 120 each may provide information such as medical records and billing, the HIE 122 may provide information such as medical records, and the PACS 124 may provide information such as diagnostic imaging and reports.

The medical information consumers 117, which may be made of a host of entities or individuals, such as patients, clinics, medical institutions, health organization, and any other medical-related party, use information that is provided by the processor 115 of MINE 112 and that can, by way of example, consist of patients, medical systems, medical organization administrators, medical researchers, and/or EHR users. For example, user-customized processed medical information is provided by the processor 115 to a number of users within the medical information consumers 117. In this case, the processor 115 generates user-customized processed medical information to a plurality of users, with at least a portion of the user-customize processed medical information being provided to each of the users based on the relevancy of the portion being provided of each user's specific function or role and each user's associated security privileges.

The processor 116, in some embodiments, indexes identifies, maps, and consolidates medical information, received from the interface 113, and tags this information, and determines to reconcile the tagged information. In some methods and embodiments, information that is extracted from images is tagged to enhance recall of search queries. Indexing, at least in part, processes document and converts them into formats that allows for quick searching across a large collection of documents.

The information in the MINE 112 is encrypted and secure to ensure privacy of sensitive medical information.

It is understood that the sources 114 of FIG. 1 includes merely some examples of the sources that communicate with the MINE 112 and that other sources, known to those in the field, are contemplated. Similarly, the output 117 may be used by those or entities not discussed herein but that are contemplated and within the scope and spirit of the invention.

The interface 113 serves to receive information that is in various forms, such as but not limited to text, html, CCD, CCR, HL7 and any other type or formatted information. The interface 113 then provides to the processors 115 and 116 information, as needed.

The processor 116 receives some of the medical information that the interface 113 processes and performs certain tasks to process it, such as indexing, semantic meta-tagging, and reconciliation. Indexing takes processed documents and converts them into formats that make it easy to quickly search across a large collection of documents. Semantic meta-tagging embeds information into the medical information that is relevant thereto and that can be later used to search for certain information for the purpose of reconciliation and search, among many others.

One aspect of consolidation, reconciliation and de-duplication, generally refers to removing of redundant patient medical records, such as, multiple records for the same individual appearing as though the records are for different individuals or multiple data elements that are recorded similarly but slightly differently in the different sources. In this case, the processor 116 recognizes that the records belong to a single individual or are the same data and just recorded differently and automatically consolidates them. The patient or a user of the system 100 may also manually perform reconciliation. The processor 116 advantageously determines whether or not reconciliation is performed.

The processor 116 outputs the indexed, tagged and reconciled information to the processor 115. The foregoing tasks are a generalization and further details of each are provided below.

The processor 115 performs certain tasks on the information provided by the interface 113 and the processor 116, which include query, search, presentation, and quality checking. The output of the processor 115 is the output of the MINE 112, or output 117.

The MINE 112, through the processor 115, in some embodiments and methods, invites members of a medical care team to join it thereby allowing distributed user-organized care teams.

Querying, as performed by the processor 115, is the ability to receive, as input, a free text query, from a user, (i.e., a query without any restrictions on the structure)—and converting the free text query into commands to a medical search engine, such as Medical Lexical Search Engine and the MATRIX (Medical Application Terminology Relationship IndeX) Concept Search Engine, using a sophisticated query processing engine optimized to work with medical queries. The results of the search engine are sent to the presentation display planner—which decides the most relevant presentation given the user's organization and role (e.g. the provider, search query program, a healthcare administrator, a study administrator, and the patient). The presentation discussed below, receives such information. In some embodiments and methods, the medical information or user information is processed to suggest relevant queries.

Search, as performed by the processor 115, is built around the concept of Zero-Click Relevance—or the ability to get to all the relevant information an actor in the healthcare system requires by typing in just a single query. The search engine, within the processor 115, performing the search comprises an indexing and searching, as will become apparent shortly. Optionally, search results may be securely embedded into third party programs. In some embodiments, searching involves determining presenting (also referred to herein as “providing”) access to specific relevant data based on a search query, the patient, and the user's specific function and/or role and security privileges. A user may be within the output 117 and security privileges are either determined by the MINE 112 or by the patient or both. The information that is uploaded to the MINE 112 by users, such as in output 114 (in some embodiments) is searched by the processor 115. The uploaded information may include information such as but not limited to status posts, records, and images. Such user-uploaded information is routed automatically to the output 117, as needed.

Some aspects of the search are now discussed relevant to an example. Assuming, by way of example, that Dr. Smith, an internal medicine physician, sees a new patient, Joan Sample, who presents with a complaint of chest pain. Joan has brought several continuity-of-care documents (CCDs) and a 600-page pdf file representing of her medical chart. She has seen a cardiologist who uses NextGen's electronic medical record (EMR) and a gastroenterologist who uses eMD's EMR and she has recently visited a local emergency room. Dr. Smith uses the search of the various methods and embodiments of the invention to efficiently assemble the relevant information he needs. Dr. Smith selects Joan Sample as the patient and enters the clinical context “chest pain” in the search bar of a screen presented by the MINE 112 (examples of such screens are shown in subsequent figures herein). He is presented with relevant lab results, such as CKMB, troponin, and amylase, relevant diagnostic results, such as prior electrocardiograms (EKGs) and the most recent chest computed tomography (CT) scan; and all progress notes and consult reports in which concepts relevant to chest pain, like “GERD” and “cardiac stress test”, are mentioned. Two distinct types of searches are combined, in accordance with a method and embodiment of the invention, to retrieve information medically relevant to Joan's complaint: 1) Lexical search, where text in the patient record is searched for occurrences of the search term, its variants and synonyms; and 2) Medical concept search, where data that is medically related to the search term is retrieved. Medical concept search finds relevant structured data with standardized codes, such as lab results, and text results, such as progress notes, which include terms medically related to the search term. In Joan's case, a search for “chest pain” returns a CKMB lab result and a reference to the most recent chest CT scan. Accordingly and advantageously, the Lexical and Medical concept search solves Dr. Smith's information overload problem by returning information in the chart most relevant to determining the etiology of Joan's chest pain complaint. Further, in some embodiments, the presentation, discussed shortly, presents a united view of Joan's history by reconciling and de-duplicating data from multiple sources that may be coded and described differently. Redundant data is automatically reconciled even if it is described differently by differently sources.

Presentation, as performed by the processor 115, is displaying health information to the requesting user in a way that reduces the number of clicks and maximizes the amount of meaningful information delivered based on the interpreting the intent of the user query.

Quality checking, as performed by the processor 115, is checking of the quality of medical information provided by various sources, i.e. source 114, by the patients, structured data, and unstructured data, in a Wiki-like mannered setting whereby the users can help maintain and improve the quality of information displayed. The foregoing tasks, performed by the processor 115, are further described in detail below. Additionally, the users or patients may make comments regarding medical information, in a Wiki-like manner.

In summary, the MINE 112 transacts medical information including the interface 113 receiving medical information from a number of medical sources (such as within the source 114) for processing, identifying, mapping, and consolidating by the medical processor 116, providing access to specific relevant data, based on a user's security privileges, within the identified, mapped, and consolidated medical information, based on user-specific functions or roles, performed by the processor 115, and generating user-customized processed medical information to a number of users, such as within the output 117, with at least a portion of the user-customized processed medical information being provided to each of the users based on its relevancy to each user's specific function or role and each user's associated security privileges.

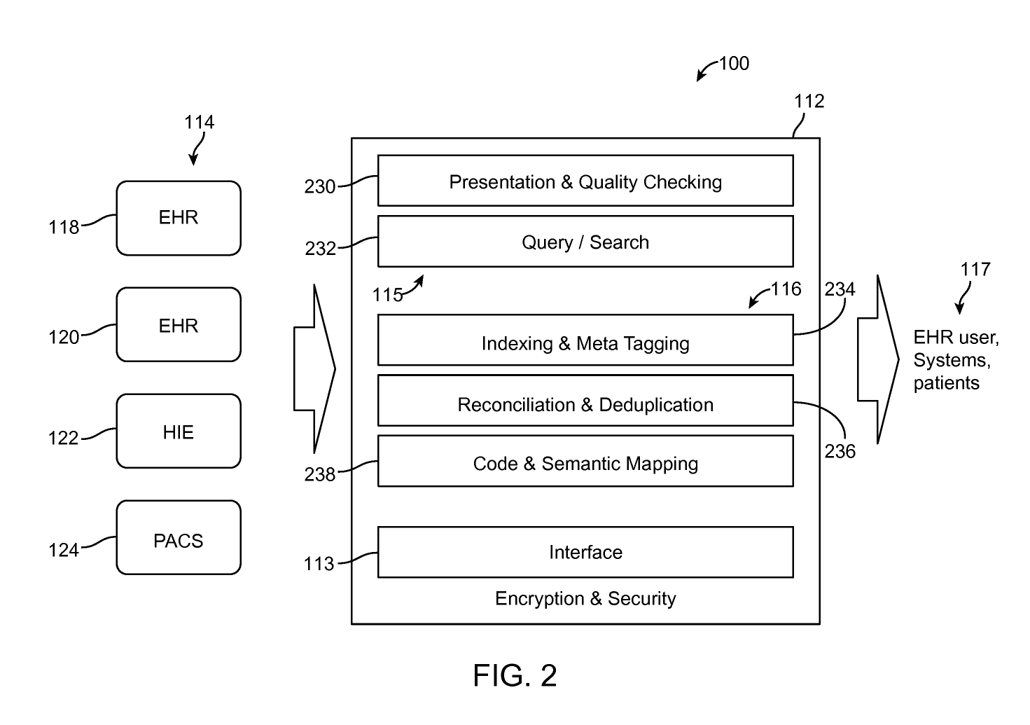

FIG. 2 shows further details of the system 100, particularly the MINE 112 thereof. That is, the processor 116 is shown to include an indexing and metal tagging module 234, which includes an indexing module and a meta tagging module (both of which are not shown in FIG. 2 in the interest of clarity), which may be a module, as shown in FIG. 2 or two physically separate modules. The processor 116 is further shown to include a reconciliation and de-duplication module 236, which also can be broken out into two modules, a reconciliation module and a de-duplication module, and a code and semantic mapping module 238, which also may be a single module or multiple modules. The modules 234, 236, and 238 communicate with one another.

The processor 115, in some embodiments, includes display and visualization 340 executing on one or more servers 238, which may be any suitable computing engine, similar to the servers 232, including but not limited to PCs or servers. The display 340 is used to construct presentation and display information to users, such as the patient's records, billing information, and other types of medical information. The display 340, in some embodiments, also performs processing of some of the functions of the processor 115.

The foregoing modules may be software programs, executed by a computer or computing engine of suitable sorts, or may be implemented in hardware.

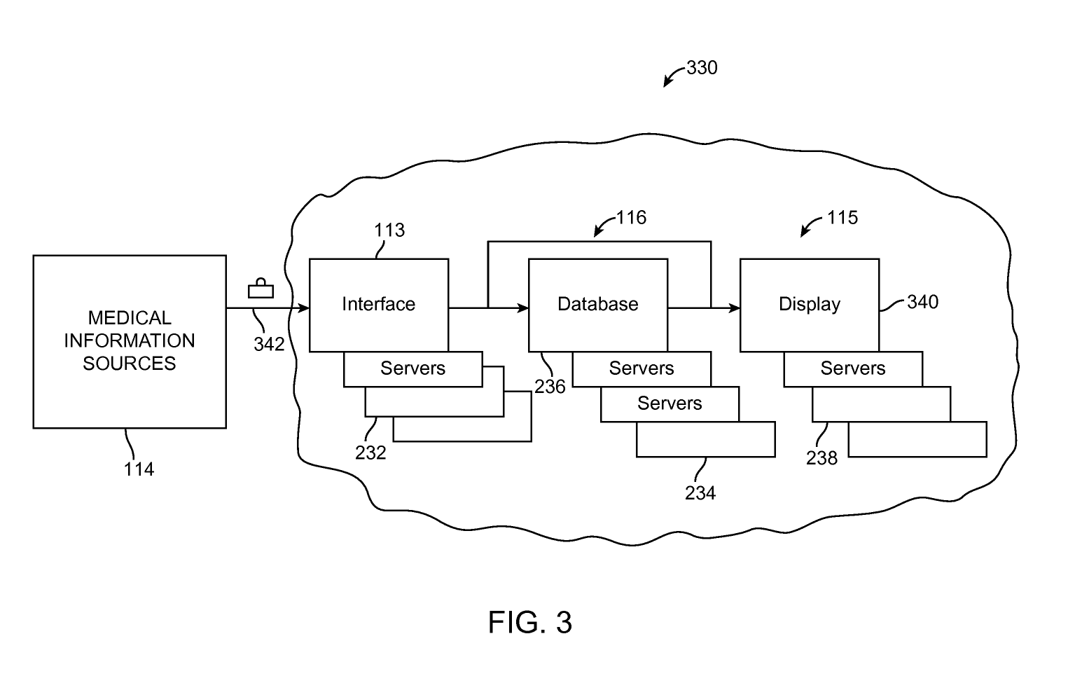

FIG. 3 shows an exemplary embodiment implementing the system 100 using various devices. That is, the medical system 330 is analogous to the system 100 and is shown to include the sources 114 coupled to communicate, securely, through the secure communication link 342, to the interface 113. The link 342 may be any suitable communication channel allowing information, of various formats and types, to be transferred to the interface 113 in a secure and encrypted fashion. Exemplary communication channels of which the link 342 is made include the Internet, VPN connections over the Internet, private dedicated digital lines such as T1, T3, E1, E3, SONET, and other fiber optic formats.

The interface 113, in some embodiments, is a software program that executes on one or more servers 232, which can be a server of any kind of suitable computing engine, such as personal computer (PC). The servers 232 receive secure information through the link 342 from the sources 114. The processor 116, in some embodiments, includes the module 236 and one or more servers 234, which may be any suitable computing engine, similar to the servers 232, including but not limited to PCs or servers.

The module 236 and servers 234 perform the tasks discussed above relative to the processor 116 and the display 340 and servers 238 perform the tasks discussed above relative to the processor 115 though these processors may and often perform additional tasks related to medical information, some examples of which are presented and discussed below and the rest of which are contemplated and achieve the various advantages, results and functions presented herein.

The processor 115, in some embodiments, includes display and visualization 340 executing on one or more servers 238, which may be any suitable computing engine, similar to the servers 232, including but not limited to PCs or servers. The display 340 is used to construct presentation and display information to users, such as the patient's records, billing information, and other types of medical information. The display 340, in some embodiments, also performs processing of some of the functions of the processor 115.

As shown in FIG. 3, the servers 232 are coupled to the module 236 and the servers 234, and to the display 340 and the servers 238 and the module 236 and servers 232 are coupled to the display 340 and the servers 238.

In some embodiments, the interface 113, servers 232, module 236, servers 234, display 340, and servers 238 are remotely located relative to the sources 114 and in some embodiments, remotely located relative to one another. Further, they are considered a part of the Internet cloud where, performing their tasks in a manner known as “cloud-computing”. However, other manner of achieving the functions and advantages of the invention, including various other of implementation, not shown in FIG. 3 or other figures herein and/or not discussed are contemplated.

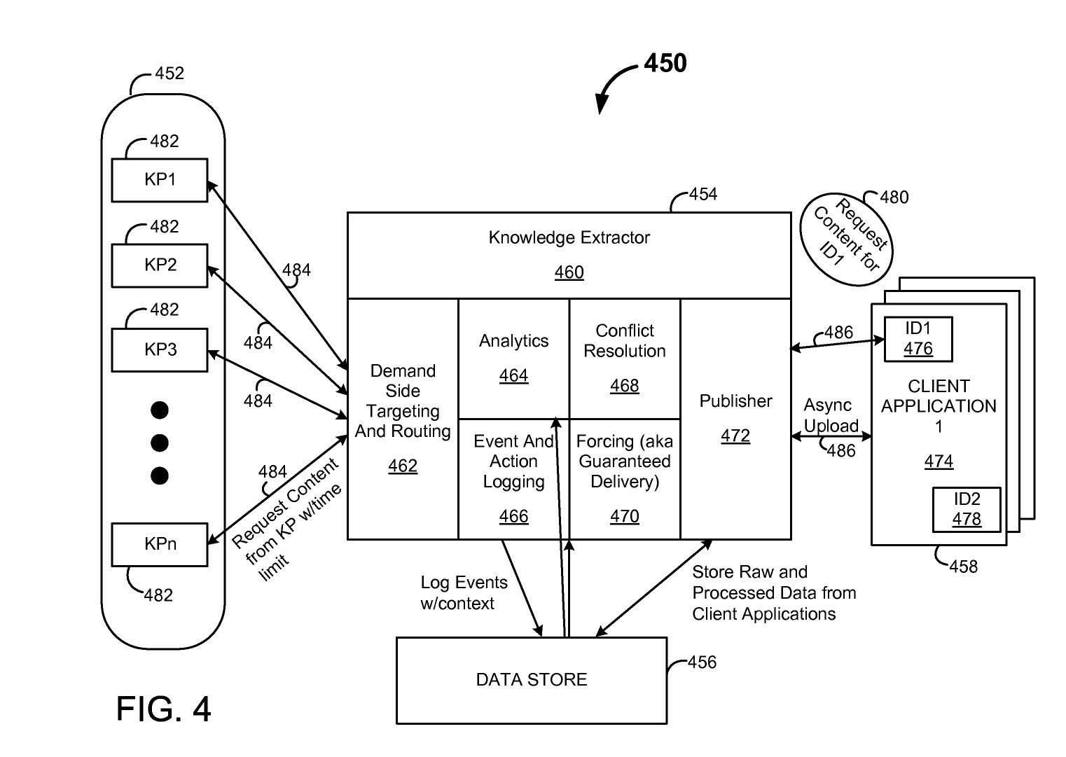

FIG. 4 shows a block diagram of a knowledge extraction system 450, in accordance with an embodiment of the invention. The system 450 is shown to include a knowledge provider block 452, a knowledge extraction and exchange unit 454, a data store block 456, and a client application block 458. The block 458 executes client or user application 474. The block 452 is analogous to the sources 114 of FIG. 1 and is shown to include a number of knowledge providers 482, with each knowledge provider being analogous to one of the sources discussed above relative to the sources 114. The knowledge extraction and exchange unit 454 is the back-end medical processor, shown in FIGS. 1 and 2. The knowledge extraction and exchange unit 454 is shown to include a demand-side targeting and routing block 462, an analytics block 464, an event and action logging block 466, a conflict resolution block 468, a forcing (or guaranteed delivery) block 470, a publisher block 472, and a knowledge extraction block 460. The block 458 is shown to include one or more impression domain (ID) blocks 476 and 478. While two ID blocks are shown in FIG. 4, it is understood that any number of ID blocks (e.g. problems, procedures, medications, allergies, “did you know?”, patient safety items, billing enhancement items, and the like), as required by a user of the system 450, may be employed.

The knowledge extraction and exchange block 454 generally manages the overall process of delivering “content” to the ID blocks 476 and 478 including managing the data store block 456, managing interactions with the knowledge providers 482 and determining which results to present to the client application block 458 (which is generally analogous to the front end processor 115 of FIGS. 1 and 2) when a request of “content” is made by one of the ID blocks 476 and 478 and how to rank the requested results. An example of a request is shown at 480 in FIG. 4 where the block 476 is making the request. “Content”, as used herein, refers to any information pertinent to the ID, for example a query string, image or hyperlink.

The data store block 456 is generally a storage device or a database storing raw and processed data received from the block 474, through the unit 454. Raw data is data that comes directly from the application 474. Processed data is data that has been processed or optimized for efficient use by knowledge providers. The knowledge extraction and exchange block 454 causes events to be logged with context into the data store block 456 when data is being stored therein. “Events” as used herein refers to user actions such as clicking on a particular content item during a particular search “context”.

The knowledge extraction and exchange block 454 communicates with the client application block 458 bi-directionally and typically asynchronously such that when there is a change to the underlying data in the application of the block 458, such as an update to the patient chart, the block 458 sends this updated data to the publisher block 472. The client application block 458 is a client or user application with each of its ID blocks querying for and displaying its particular impression domain content. By way of example only, impression domain content includes items such as problems, procedures, medications, allergies, “did you know?”, patient safety items, billing enhancement items, and so on . . . . Each ID presents information to the user that is relevant to the specific patient/user/context at the time the information is displayed. For example, a patient safety ID would present a patient's past history of myocardial infarction to a primary care provider if that event were not noted as structured data the user's EHR application. The publisher block 472 receives content requests from the ID blocks 476 and 478 and in response returns content to be displayed in the blocks 476 and 478. Further, the block 472 receives events (such as clicks) from the ID blocks 476 and 478, receives raw data (such as patient chart updates) from the application block 474, and manages storage of data in the data store block 456 (including event logs, raw client application data and data extracted for the specific needs of the knowledge providers 482 of the block 452).

The demand side targeting and routing block 462 routes content requests to the different knowledge providers 482, received from the client application block 458 by selecting a subset of knowledge providers in real time which it considers most relevant to the current patient/user/context based on criteria provided by the knowledge provider, such as “patient covered by Medicare Advantage”, “user is a cardiologist”, or “query includes the term EKG”, and subsequently receives their responses, through the knowledge provider links 484. In some embodiments, if a knowledge provider 482 with an outstanding content request does not respond within a prescribed amount of time, the request is cancelled.

The conflict resolution block 468 receives content from the demand side targeting and routing block 462 and advantageously determines which of the responses from the knowledge providers 482 to pass to the forcing block 470 and in which rank order. The conflict resolution block 468 uses the content from the ID block 476 or 478 (e.g. patient, user, query) along with analytics on the performance of past knowledge provider results to determine which results are most likely to be useful. For example, if an endocrinologist user always clicks on the hemoglobin a1c history after performing a diabetes search, the ID for labs may start automatically displaying the history in response to a diabetes context for that particular user. If enough endocrinologists perform the same action, the ID for labs may start automatically displaying the history for all endocrinologists, whereas such an automatic action might not be performed for general practice users searching for the same diabetic context.

The forcing block 470 receives ranked and selected results from the conflict resolution block 468 and further determine to potentially override the ranking determined by the conflict resolution block 468. For example, if only one result can be displayed in a particular ID block, and it receives a high-value reimbursement result and an important patient safety result, the patient safety result might be given priority over the reimbursement result.

The event and action logging block 466 stores event and action data, such as click-through events in the data store block 456, along with context information (ID context, date, time). Event and action data refers to end user actions e.g. clicking on a particular content that is displayed for more information or history.

The analytics block 464 computes summary statistics for events and actions and places them in the data store block 456 for use by the conflict block 468. End user statistics like click-through rates and dwell times may also be computed by the analytics block 464.

Each of the ID blocks 476 and 478 sends a request to the knowledge extraction and exchange unit 454 asking for certain kinds of result (text, images, links, diagnosis codes) from the knowledge extraction and exchange unit 454. A typical request includes the number of results desired and the context of the request, such as patient identifier, user identifier (and user role, such as specialty, physician or coder or medical assistant, etc) and the search query. The ID block 476 or 478 is responsible for determining how the results are presented to the user of the system 450. For example, when an action is taken, such as a click on a search link, the ID block 476 or 478 also submits this information to the event and action logging block 466.

Each of the knowledge providers 482 computes and returns results that are relevant to a particular ID block request. In some embodiments, the knowledge providers 482 have access to the data store block 456. For example, a knowledge provider might return PubMed articles, up-to-date articles, or best treatment practices that are relevant to the patient/user/context.

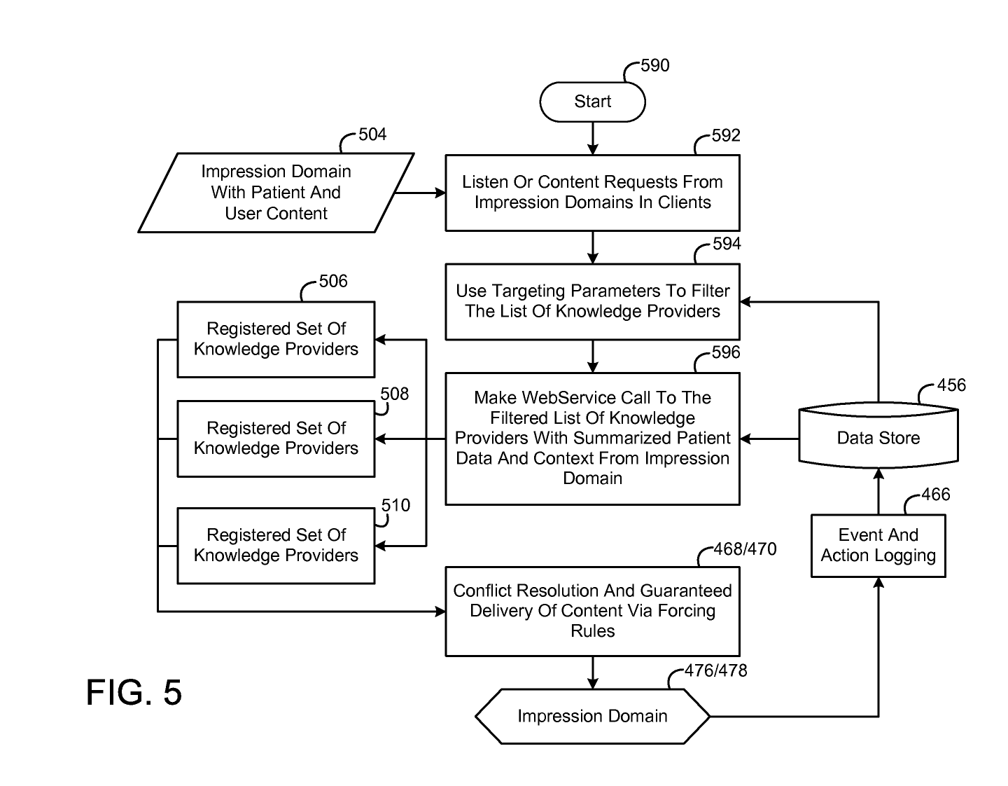

FIG. 5 shows a flow chart of some of the steps performed by the knowledge extraction and exchange unit 454 of FIG. 4, in conjunction with some of the blocks of FIG. 4 and in accordance with a method of the invention. The method starts at 590 and at step 592, content requests from the blocks 476 and 478 are awaited by the unit 454. In the meanwhile, at 504, the blocks 476 or 478 may provide the unit 454 with patient and/or user “content” and when they do, the process proceeds to step 594 where targeted parameters are used to narrow the list of knowledge providers 482 in real time based criteria provided by the knowledge provider, such as patient is covered by Medicare Advantage, user is a cardiologist or query includes the term “EKG”. Targeted parameters may be received from the block 456, which also provides information for the next step 596. A narrowed list of knowledge providers is referred to herein as “registered set of knowledge providers”. At step 596, the knowledge extraction and exchange block 454 makes webservices calls to the narrowed (or “filtered”) list of knowledge providers with a summarized patient data and context from the blocks 476 or 478 obtained by knowledge extraction block 460. The summarized patient data is then passed on to the narrowed (or “filtered”) list of knowledge providers blocks 506-510. The narrowed (or “filtered”) list of knowledge providers 506-510 provide clinically-relevant knowledge to the blocks 468 and 470 where conflict resolution is performed and delivery of content is guaranteed via forcing rules. “Forcing rules” refer to a set of rules that may override decisions made by the conflict resolution module 468.

The outcome of the blocks 468 and 470 is then provided to the block 476 or the block 478, which subsequently captures events and actions and transmits them to the block 466. These events and/or actions are stored, in their raw form, in the block 456.

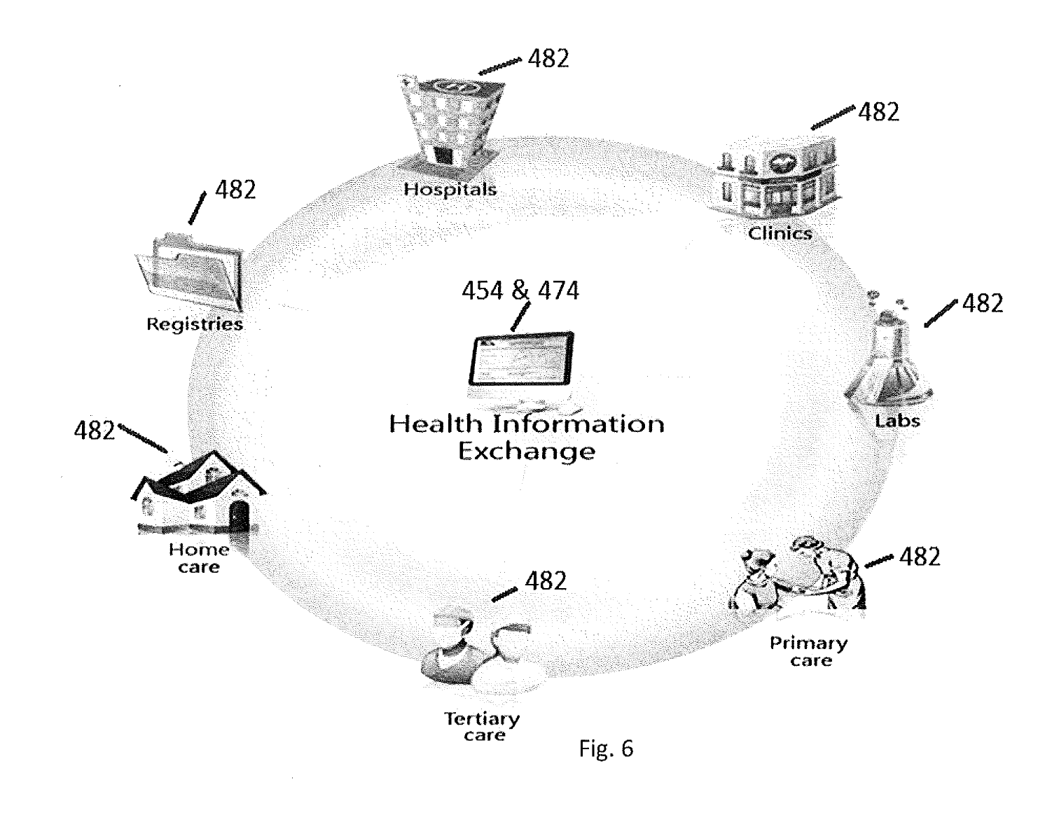

FIG. 6 shows an example of the knowledge extraction and exchange unit 454 and the client application 474 and examples of knowledge providers 482. In FIG. 6, the knowledge extraction and exchange unit 454 and the client application 474 are shown to be a mobile device and/or tablet, and the knowledge providers 482 are shown to be a home care facility, a tertiary care facility, a primary care, labs, clinics, hospitals, and registries. It is understood that the knowledge providers 482 of FIG. 6 are merely examples of knowledge providers, in fact, the knowledge providers 482 as well as the knowledge extraction and exchange unit 454 and the client application 474 can be in a field other than the medical field, such as legal services, among others that are contemplated.

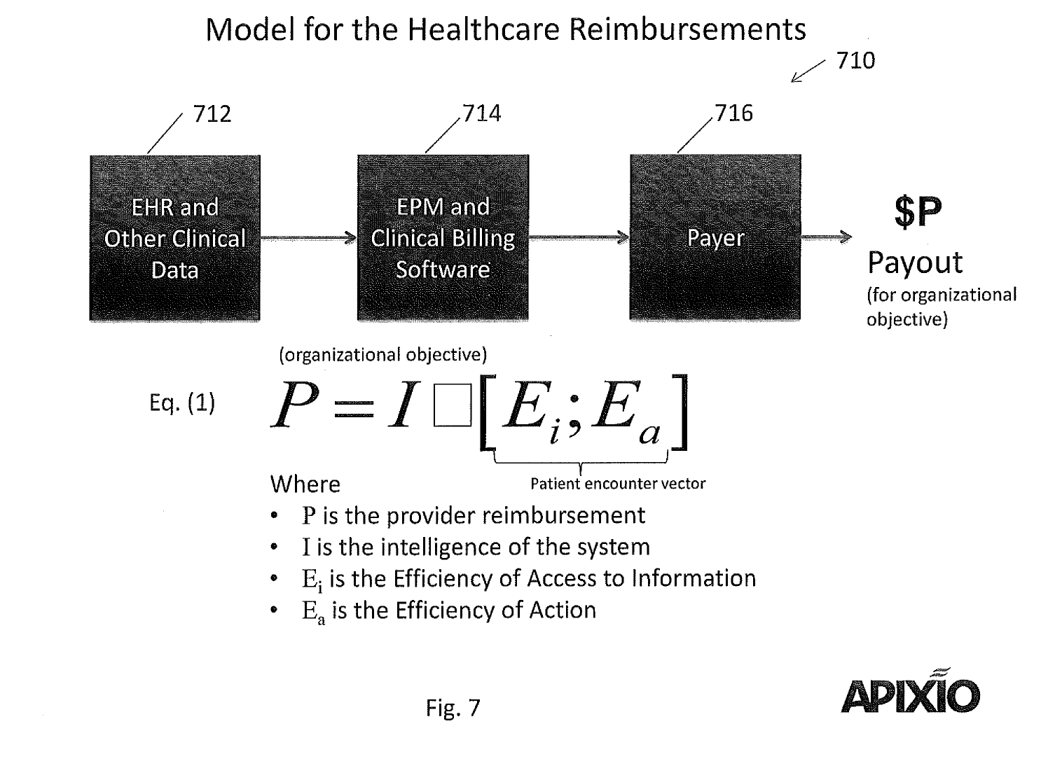

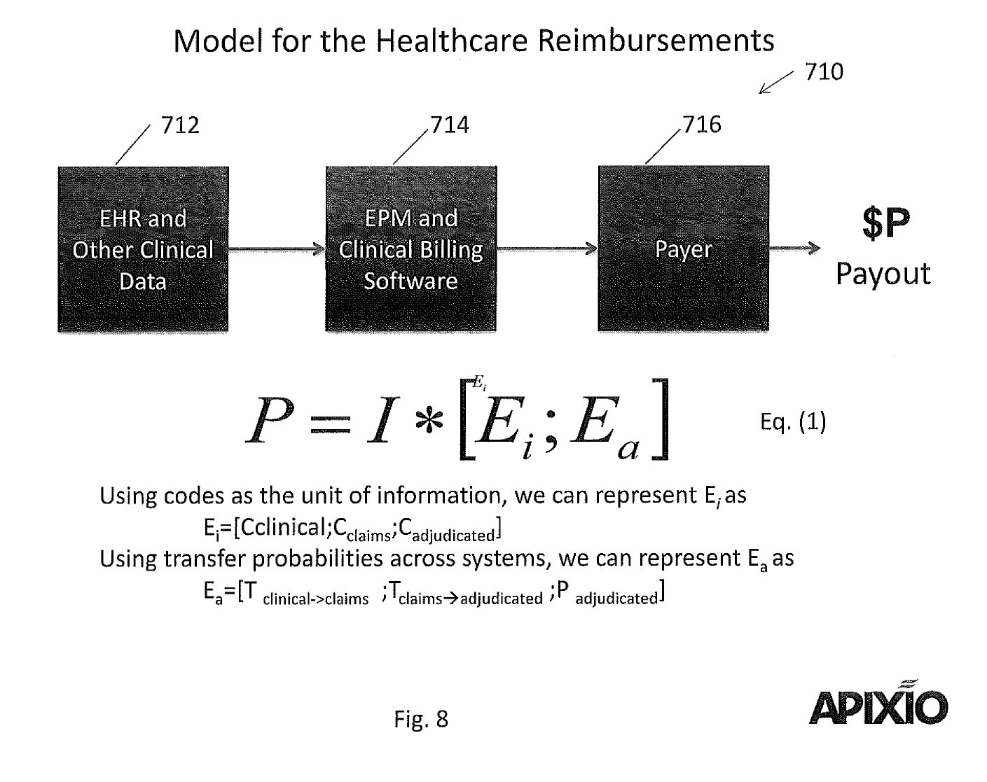

FIGS. 7 and 8 show a model of a healthcare reimbursement system, in accordance with a method and embodiment of the invention. In each figure, Eq. (1) is shown to represent the relationship between the organizational objective (P) and efficiency (I) and patient encounter vector [Eᵢ;Eₐ,]. In Eq. (I), the symbol “*” represents a multiplication operator, the symbols “[ ]” represent a matrix and the symbol “;” represents concatenation.

System for generating prompts for actions that move data from one place to another to achieve organizational objectives (P).

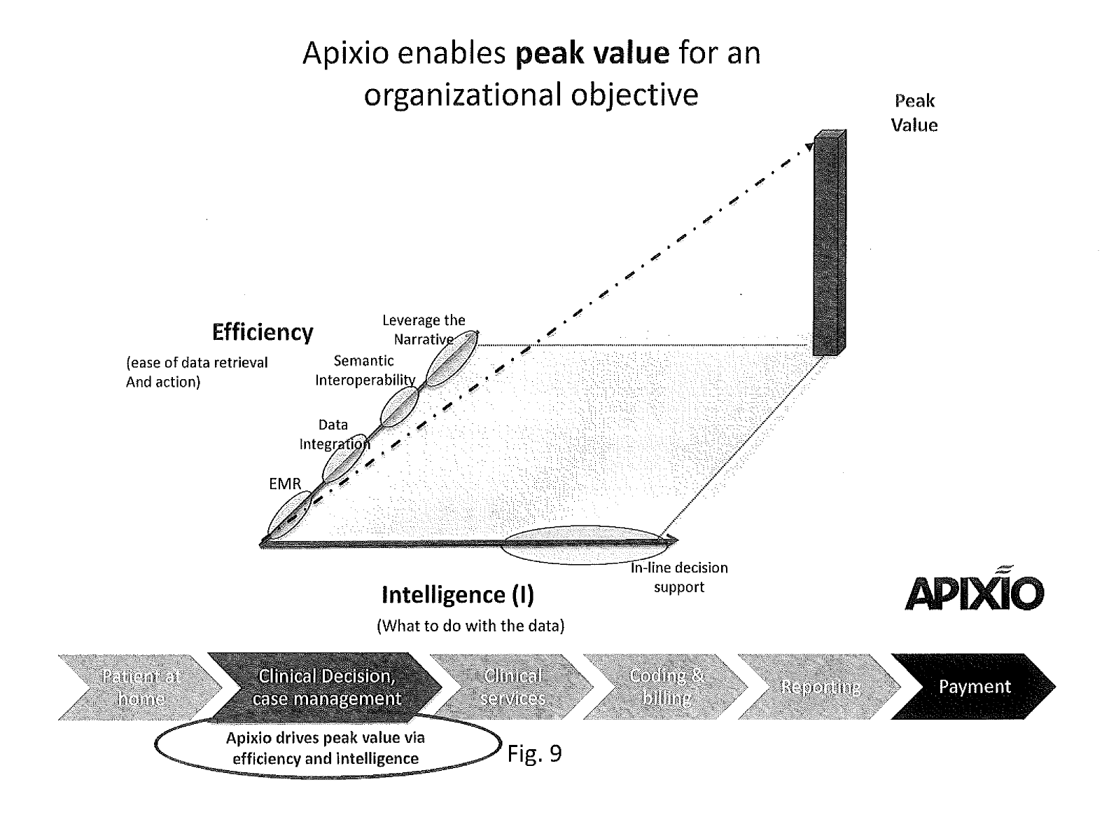

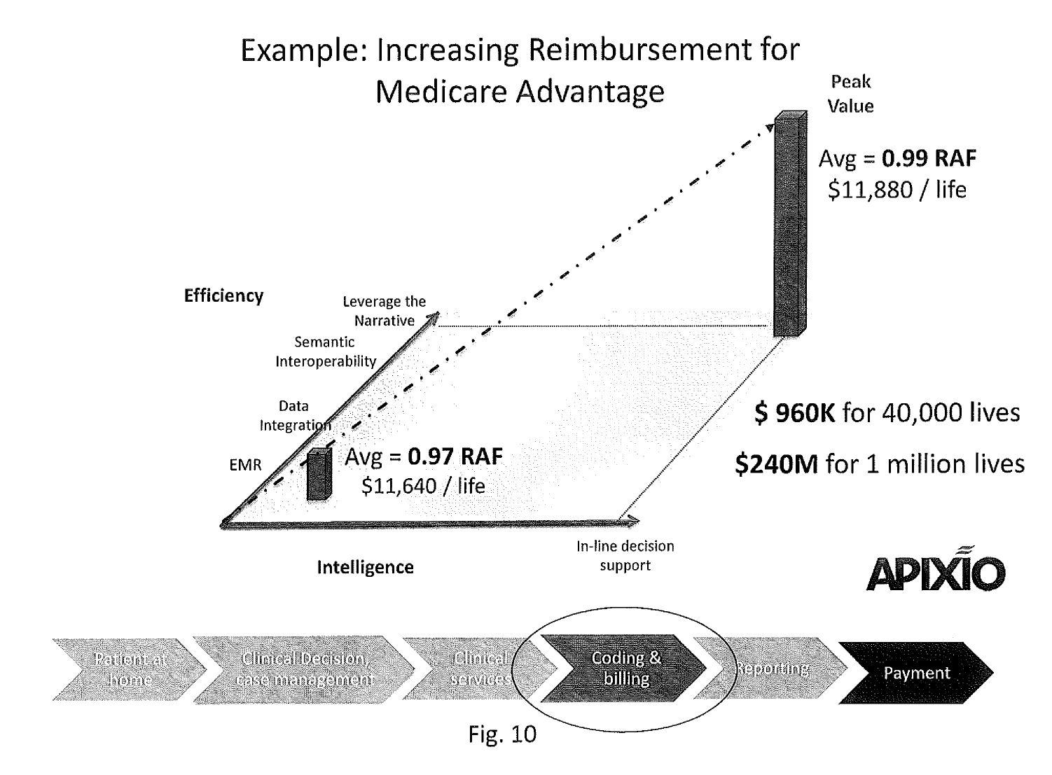

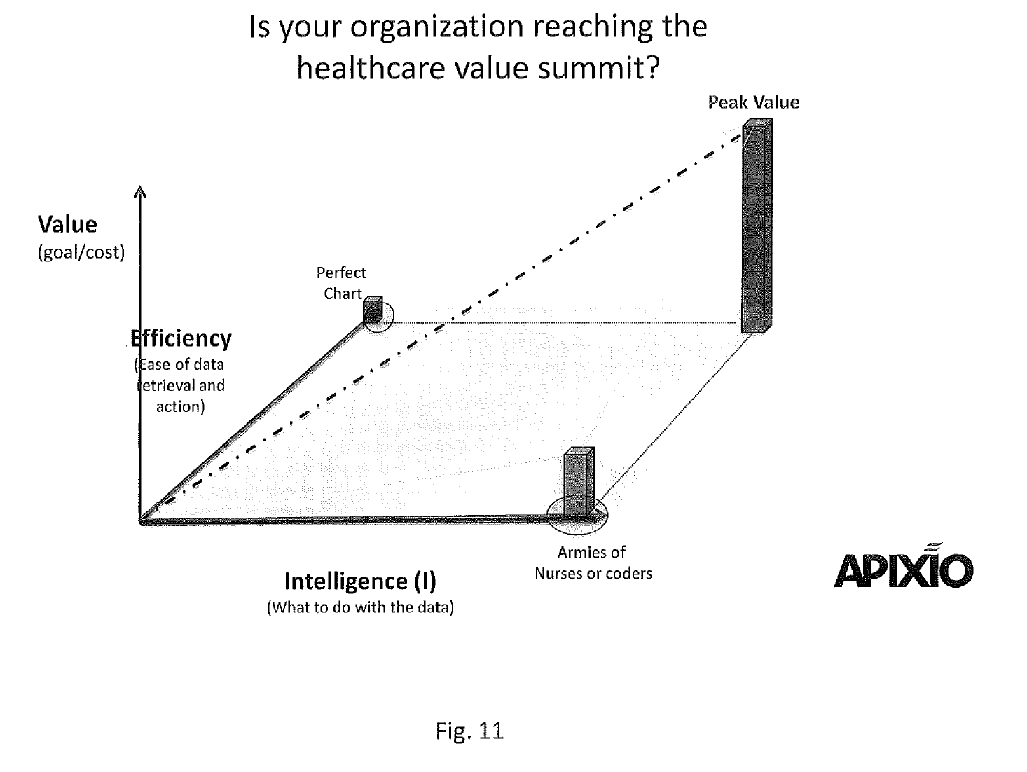

FIGS. 9-11 each show a graph of the intelligence, shown in the x-direction, versus value, shown in the y-direction, of various performance improvements realized using the various methods and embodiments of the invention.

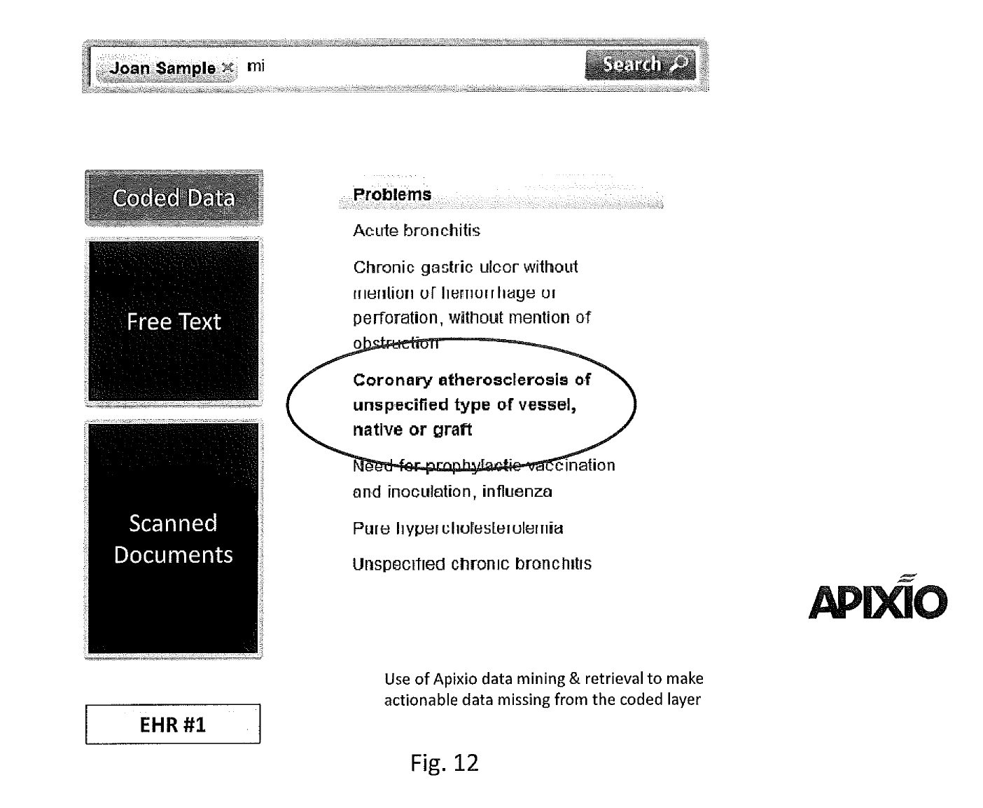

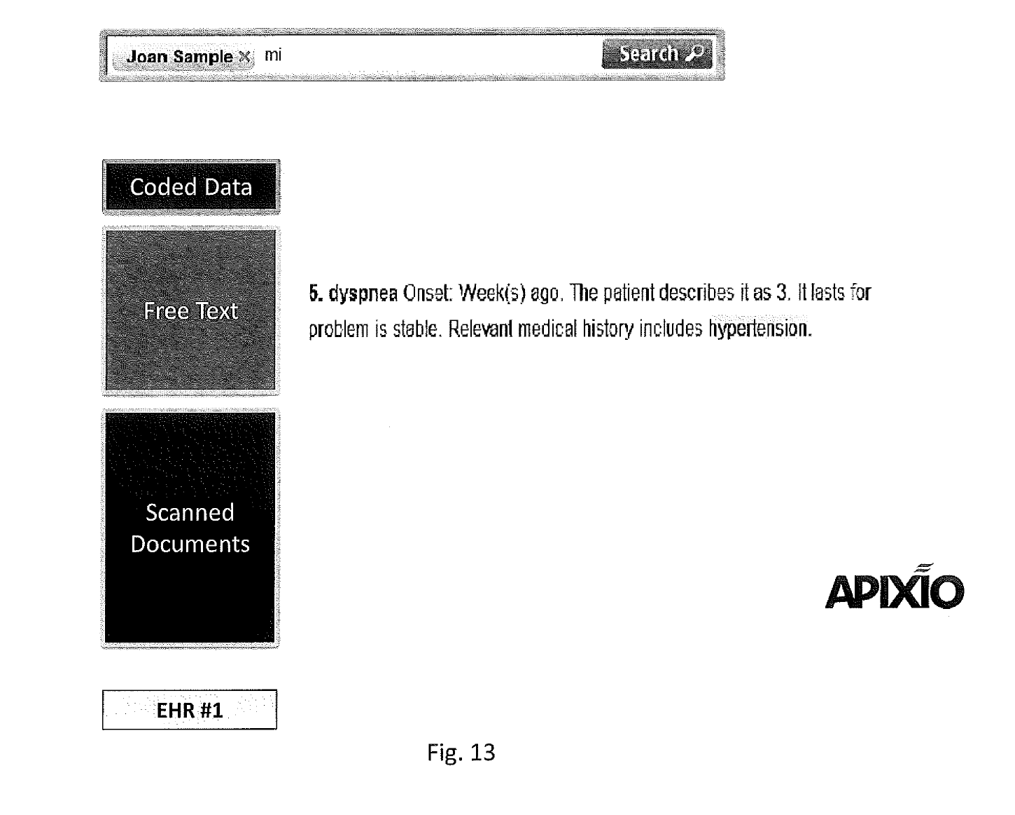

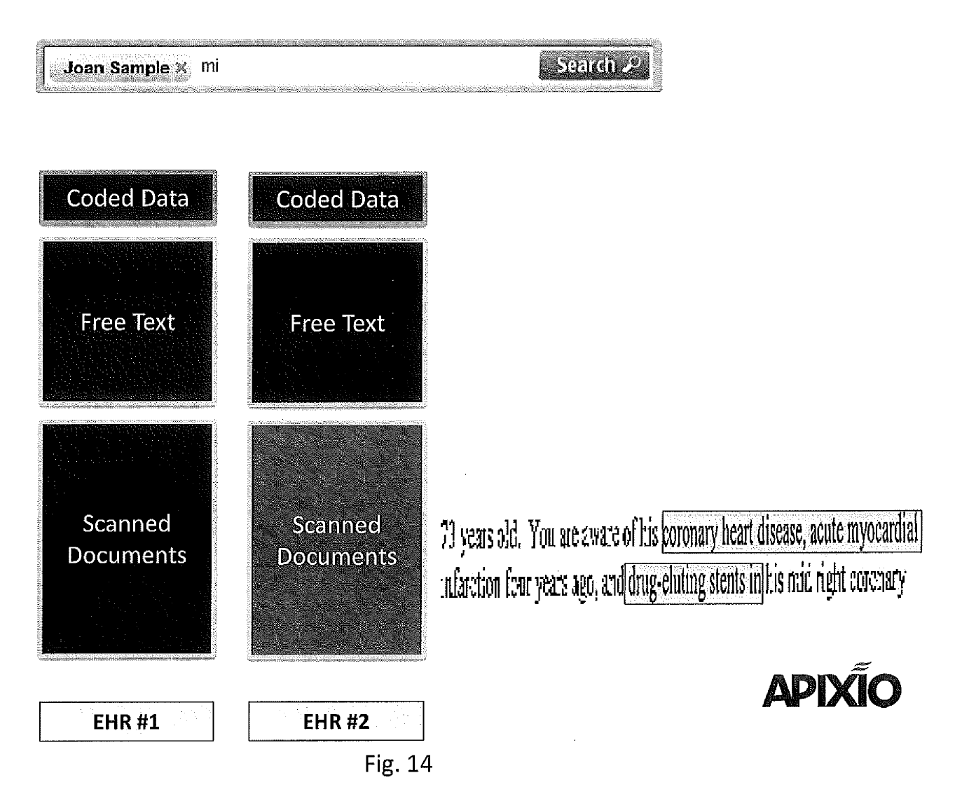

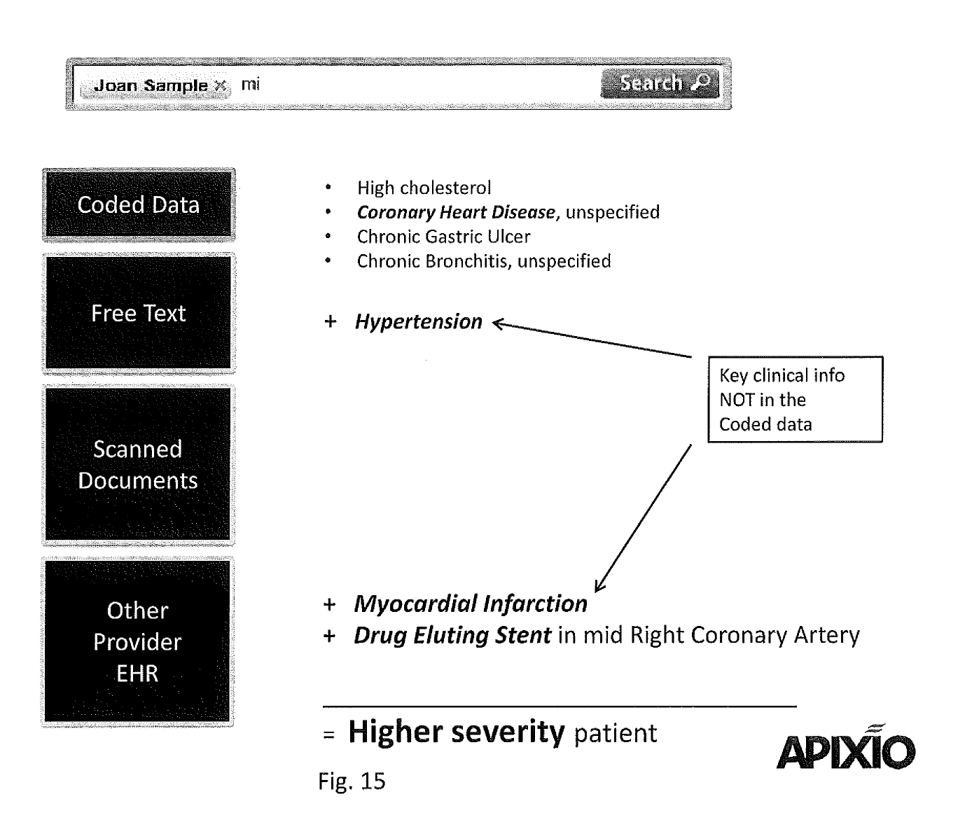

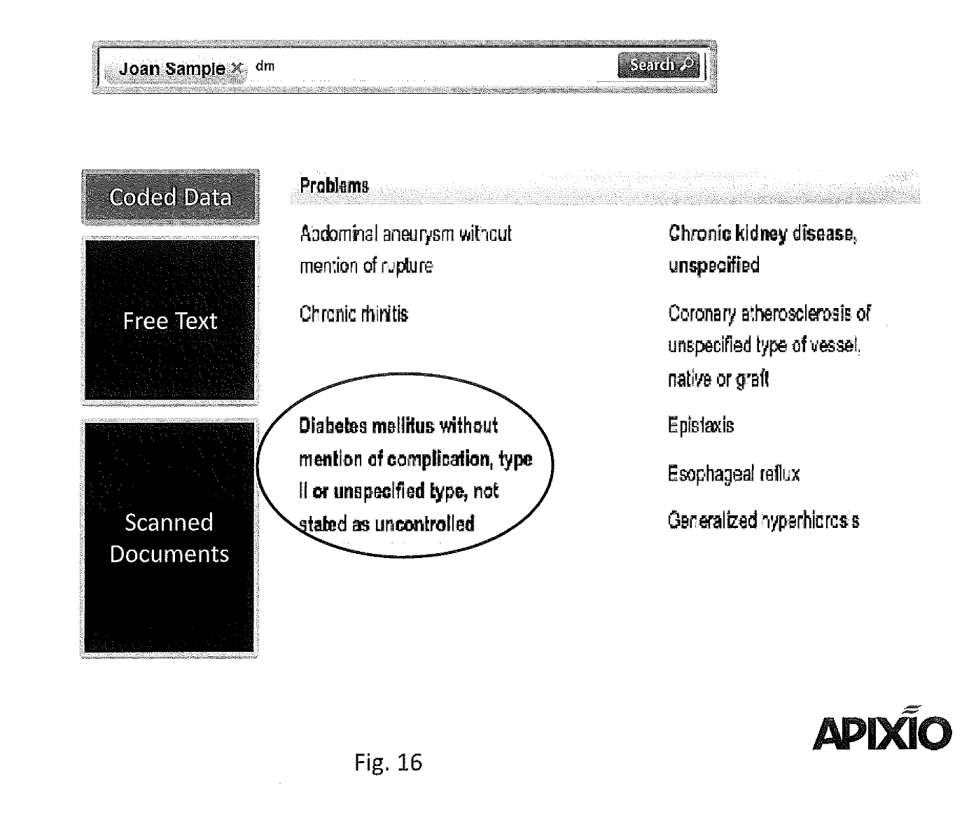

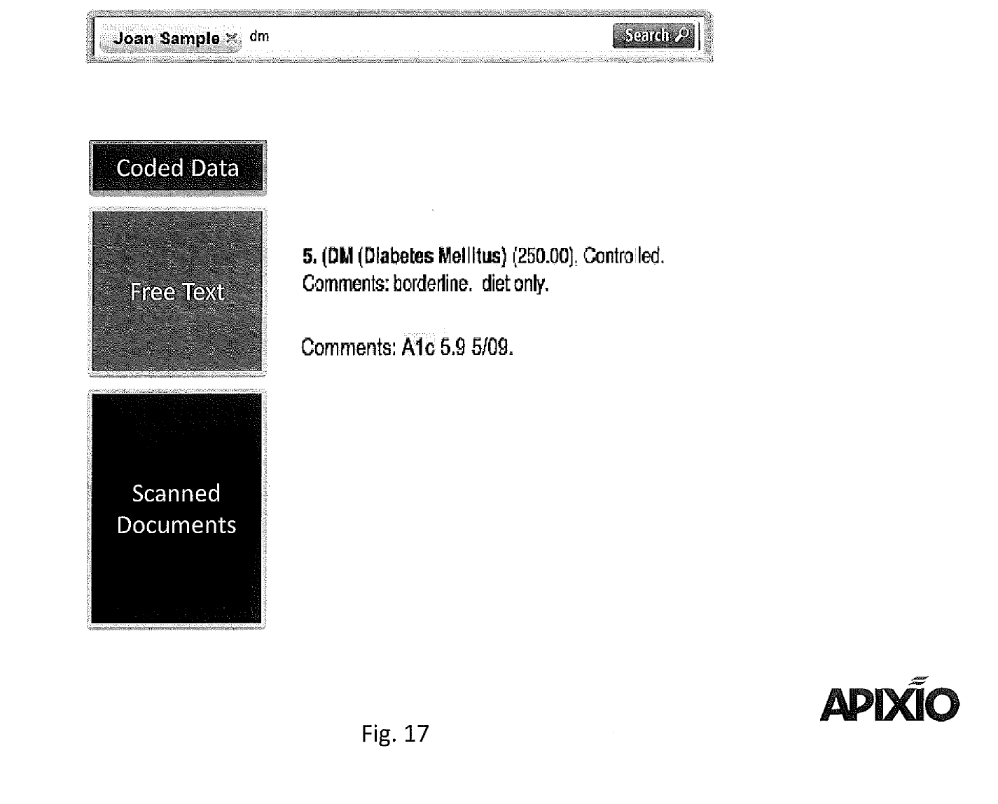

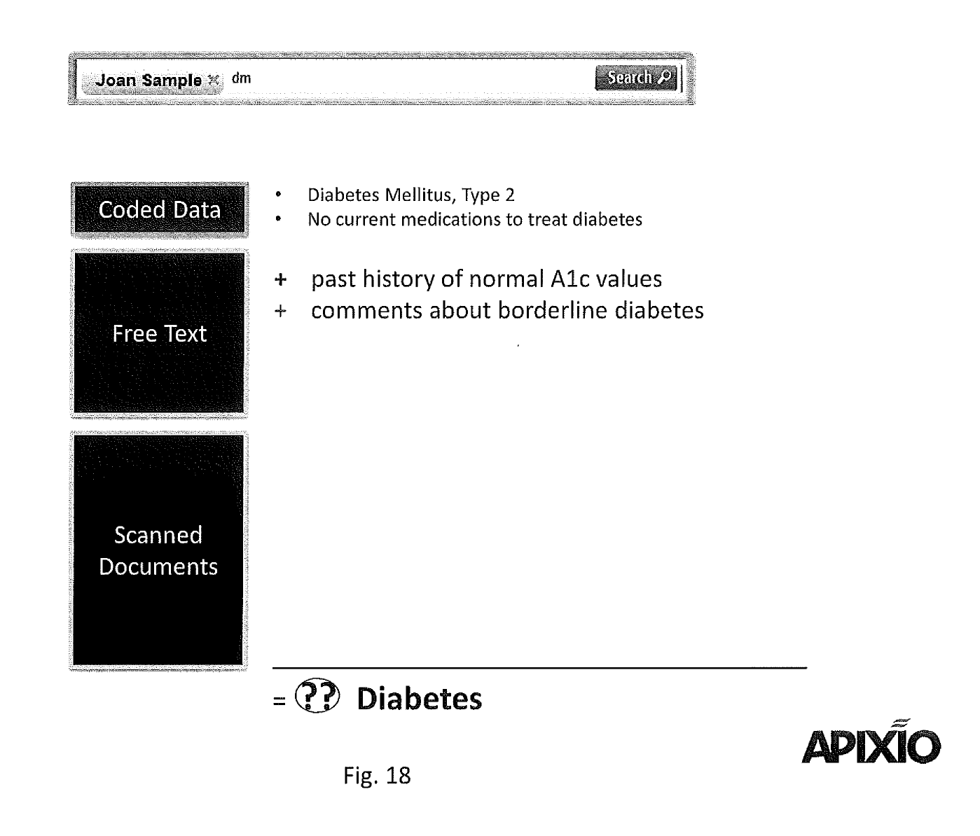

FIGS. 12-18 show an example of a patient/user, Joan Sample, benefiting from the process of extracted information used to determine potential conditions, in accordance with a method of the invention.

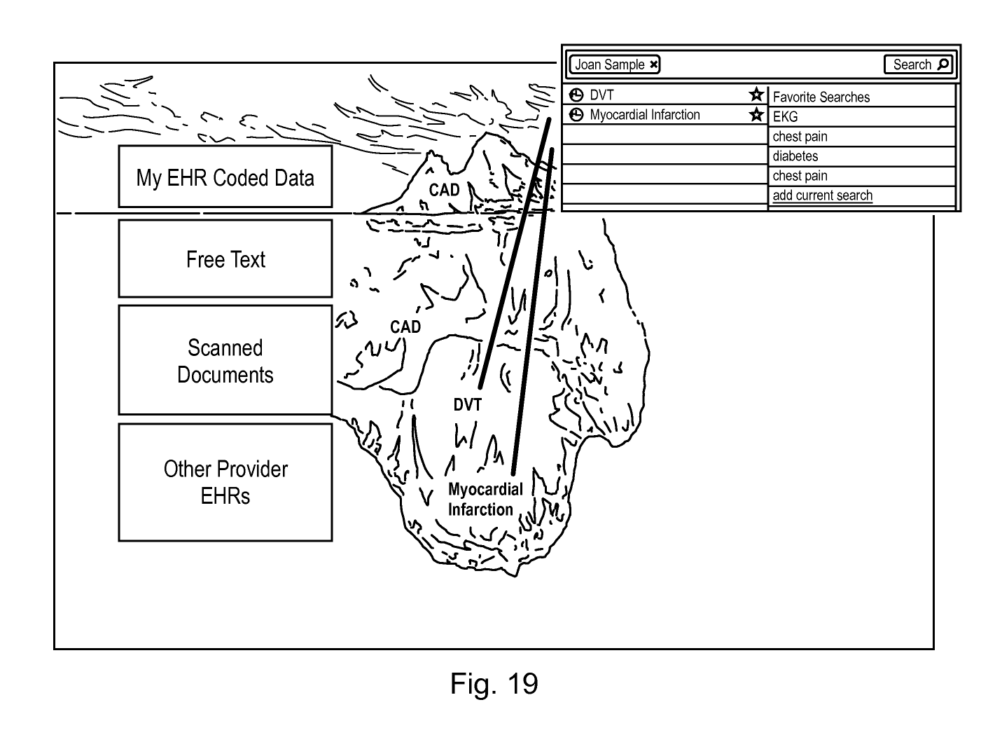

FIG. 19 shows MI and DVT extracted from otherwise hidden information, other provider EHRs and scanned documents, by using the knowledge-based extraction methods and embodiments of the invention.

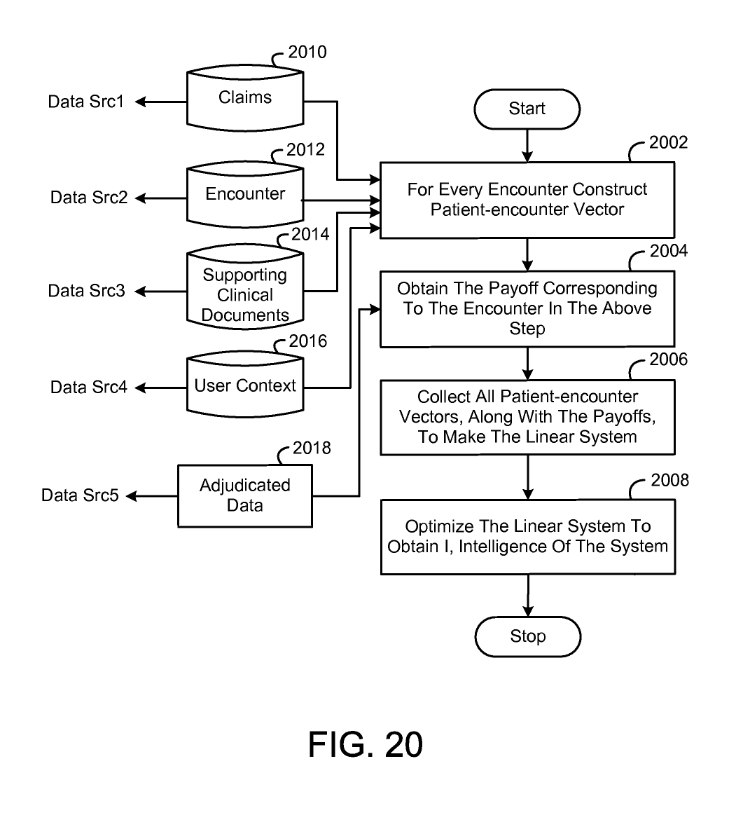

FIG. 20 shows a flow chart of the steps for determining the intelligence (I) of a healthcare system, in accordance with a method of the invention.

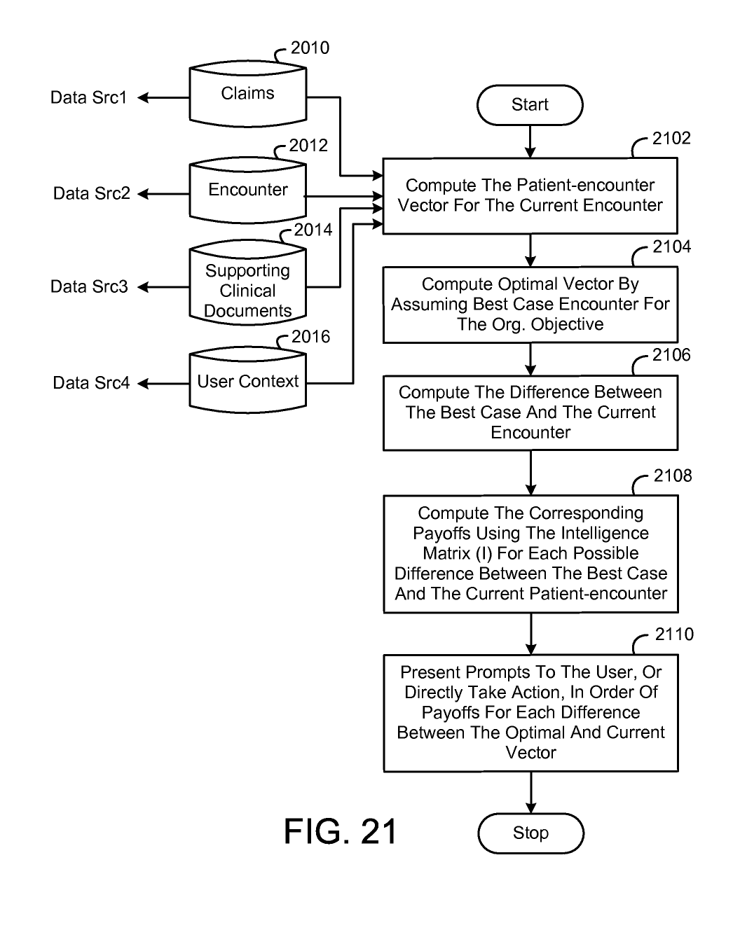

FIG. 21 shows a flow chart of the steps for application of hierarchal condition categories (HCC), in accordance with a method of the invention.

In FIG. 21, the data “src” or sources shown on the left side of the page are data that is provided by various sources, such as sources 14, in the form of claims, encounter, supporting clinical documents, and user context. In FIG. 20, the “I” or intelligence of the Eq. (1) of FIGS. 7 and 8, is determined and in this respect, show further details of a knowledge provider 482.

The steps of FIG. 21 are for application of hierarchal condition categories (HCC) and advantageously identify the first order HCC gap alerts.

Although the invention has been described in terms of specific embodiments, it is anticipated that alterations and modifications thereof will no doubt become apparent to those skilled in the art. It is therefore intended that the following claims be interpreted as covering all such alterations and modification as fall within the true spirit and scope of the invention.

What is claimed is:

1. In a Medical Information Navigation Engine (“MINE”), a computerized method for knowledge extraction and exchange, the method comprising;
computing a current patient encounter vector for a current patient encounter;
computing an optimal patient encounter vector by assuming a substantially best case patient encounter in accordance with at least one organizational objective;
computing at least one difference between the substantially best case encounter and the current patient encounter;
computing a corresponding payoff for each of the at least one difference; and
providing, in order of potential payoff, at least one difference between the optimal patient encounter vector and the current patient encounter vector.

2. The method of claim 1 further comprising collecting a plurality of patient encounter vectors and a plurality of corresponding payoffs to create a linear system.

3. The method of claim 2 wherein the linear system is optimized to obtain intelligence for the MINE.

4. The method of claim 1 wherein the corresponding payoff is computed using an intelligent matrix.

5. The method of claim 1 wherein the at least one difference between the optimal patient encounter vector and the current patient encounter vector is provided to at least one of a querying user and a querying electronic health record (HER) system.

6. A Medical Information Navigation Engine (“MINE”) configured to extract and exchange knowledge, the MINE comprising:
a processor configured to:
compute a current patient encounter vector for a current patient encounter;
compute an optimal patient encounter vector by assuming a substantially best case patient encounter in accordance with at least one organizational objective;
compute at least one difference between the substantially best case encounter and the current patient encounter; and
compute a corresponding payoff for each of the at least one difference; and
an interface configured to provide, in order of potential payoff, at least one difference between the optimal patient encounter vector and the current patient encounter vector.

7. The MINE of claim 6 wherein the processor is further configured to collect a plurality of patient encounter vectors and a plurality of corresponding payoffs, and further configured to create a linear system.

8. The MINE of claim 7 wherein the linear system is optimized to obtain intelligence for the MINE.

9. The MINE of claim 6 wherein the corresponding payoff is computed using an intelligent matrix.

10. The MINE of claim 6 wherein the at least one difference between the optimal patient encounter vector and the current patient encounter vector is provided to at least one of a querying user and a querying electronic health record (HER) system.
